(19) United States
(12) Patent Application Publication
(10) Pub. No.: US 2020/0031186 A1
(43) Pub. Date: Jan. 30, 2020

(54) LINK FOR A WHEEL SUSPENSION

(71) Applicants: THYSSENKRUPP STEEL EUROPE AG, Duisburg (DE); thyssenkrupp AG, Essen (DE)

(72) Inventors: Kai-Uwe JENTSCH, Moers (DE); Angela SEMLANOJ, Essen (DE); Daniel NIERHOFF, Mülheim a. d. Ruhr (DE); Hans-Erich GIESE, Ratingen (DE)

(73) Assignees: THYSSENKRUPP STEEL EUROPE AG, Duisburg (DE); thyssenkrupp AG, Essen (DE)

(21) Appl. No.: 15/735,666

(22) PCT Filed: Jun. 13, 2016
(86) PCT No.: PCT/EP2016/063493

§ 371 Date: Dec. 12, 2017

(30) Foreign Application Priority Data
Jun. 18, 2015 (DE) 10 2015 211 191.1

(51) Int. Cl. B60G 7/00; F16C 7/08

(52) U.S. Cl. CPC B60G 7/001; F16C 7/08; B60G 2206/11; B60G 2206/8201; B60G 2206/722; B60G 2206/8102; B60G 2206/71

(57) ABSTRACT

A link for a wheel suspension of a vehicle may include a middle section and two end sections. The end sections may have connecting points for receiving linking and/or joining elements. The object of providing a link that has sufficient stability and rigidity throughout a service life of that link and that can be produced cost-effectively is accomplished at least in part and at least in some cases by way of the middle section of the link being formed from at least two shells. The at least two shells may in some cases have substantially U-shaped cross sections, and the at least two shells may be joined together by integral bonding, force locking, and/or form fitting in a butt joint or a lap joint.

The invention relates to a link for a wheel suspension of a vehicle comprising at least one middle section and at least two end sections, wherein the end sections have connecting points for receiving linking and/or joining elements.

Links, especially tensile or compressive links, are used in automotive engineering in the region of the wheel suspension in order to make possible a connection between the bodywork and the wheel carriers. The forces acting on the vehicle as a result of acceleration, braking and driving curves task an enormous strain on the links. The requirements placed on the link must satisfy these factors. Therefore, the mounting of the link must be designed so that a certain stability and rigidity of the component is assured. In order to meet the demands, but also due to restricted installation space on account of the especially articulated front wheels and the free mobility of the drive shafts, forged and cast parts are conventionally used for example in the front axle region, especially parts made of aluminum. Forged and cast parts are relatively costly to produce.

Starting from the prior art explained above, the object of the present invention is to provide a link which has sufficient stability and rigidity throughout the service life of the component and which can be produced cost-effectively.

The object is achieved in that at least the middle section of the link is formed from at least two shells.

The production of the shells, especially half-shells, is done for example by means of deep drawing or bending of appropriately configured sheets, which are for example cut to length from a striplike semi-finished product and trimmed preferably down to the developable surfaces of the geometries being created by shaping, especially by deep drawing. These forming processes are favorable alternatives to casting or forging. Thanks to the shell construction, economical links can therefore be produced. Furthermore, especially when using a deep drawing for sizing, half-shells with good dimensional stability can be created, and a slight material excess along at least a portion of the shell edge to be subject to upsetting can be taken into account for the upsetting process taking place during the deep drawing for sizing. For example, more than two shells can also be provided to form the middle section of the link.

According to a first embodiment of the invention, the shells are substantially U-shaped in cross section and joined together by integral bonding, force locking and/or form fitting in the butt or lap joint. The at least two shells are arranged in relation to one another at least in the middle section of the link according to the invention so that they enclose a hollow, thereby influencing the weight of the component as compared to conventionally produced links of solid material. The connection in the butt joint is especially preferred, since the material can be utilized optimally.

Preferably the U-shaped shells are formed by a bottom and two adjoining frames as a single piece, making an angle, such as a right angle, with the bottom. Depending on the configuration of the link according to the invention, the frames may also be positioned at an acute and/or obtuse angle to the bottom.

In the longitudinal direction at least in the middle section of the link according to the invention, according to another embodiment of the invention the cross sections may be constant and/or variable in configuration at least for a portion. Depending on the installation space situation, for example, the cross sections may vary appropriately in the longitudinal direction of the link according to the invention.

Besides the cross sections, according to another embodiment of the invention the height of the frames and/or the width of the bottoms in the longitudinal direction at least in the middle section of the link may be constant and/or variable in configuration. Thus, in advantageous manner, many design options in space (3D) may be implemented, wherein the two frames of the respective shell, especially a half-shell, may have different and locally varying heights, while the overall height of the component may vary along the length or be individually configured.

According to another embodiment of the invention the shells may have different thicknesses. This has the advantage that the weight of the link and the strength and/or rigidity can be further optimized and positively affect the space requirement or the installation space in the chassis area. The thicknesses amount to in each case 0.3 to 4.5 mm, especially 0.5 to 4.0 mm, preferably 0.8 to 3.5 mm and especially preferably 1.0 to 3.0 mm.

According to another embodiment of the invention the shells consist of a steel, aluminum, fiber composite or sandwich material. Depending on the requirement, the link may be composed of one material or different materials. Sandwich materials may comprise different kinds of material (such as metal/plastic/metal) or different materials of one category (such as a metallic material composite).

According to a preferred embodiment of the invention at least one of the shells consists of a lightweight steel. In particular, highly extensible steel materials, such as those with high manganese content, are very well suited to the production of complex geometries on account of their high ductility along with high strengths throughout the service life of the component.

According to another embodiment of the invention, a means of receiving linking and/or joining elements at least at one end section, being preferably annular in configuration, is connected by integral bonding, force locking, and/or form fitting at least to the middle section of the link. Preferably, the shells forming at least the middle section protrude at least for a portion into the end section in order to provide a larger connection surface to the annular means. An all-around encircling of the annular means by the sheet metal shells is also conceivable. The means is preferably configured as an annular receiving piece.

According to another embodiment of the invention, a means of receiving linking and/or joining elements at least at one end section, being configured as a continuation of the middle section of the link formed by at least two shells, being preferably sleevelike in configuration, is integrated by integral bonding, force locking, and/or form fitting in the end section of the link formed from the shells. The means is preferably configured as a sleevelike receiving piece.

According to a preferred embodiment of the invention the link is a tensile and/or compressive link.

According to another embodiment of the invention at least one of the shells may have at least one embossing or corrugation. Embossings are structures increasing the rigidity and can impart a greater bending and torsional strength to the link overall.

According to another embodiment of the invention at least one of the shells may have at least one cavity. Cavities enable a further reduction in weight of the link. The areas where mass can be economized and thus the weight can be reduced are generally determined specifically to the component, for example by means of simulation.

The application of the link according to the invention is not limited to motor vehicles (cars), but also this link can be considered for utility vehicles, special vehicles, as well as railway vehicles.

The invention shall be explained in more detail below with the aid of a drawing illustrating sample embodiments. The same parts are given the same reference numerals. In the figures,

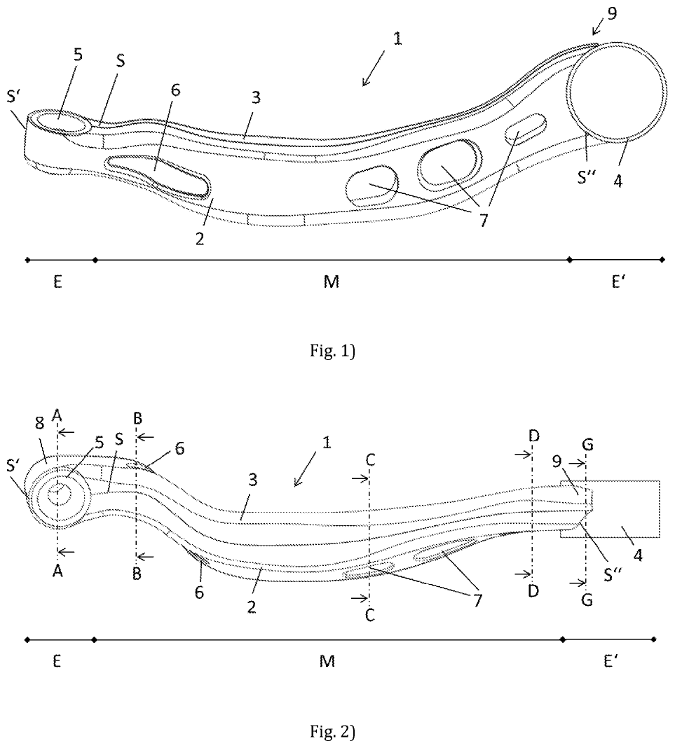

FIG. 1 shows a link according to the invention in top view;

FIG. 2 shows the link according to the invention from FIG. 1 in side view;

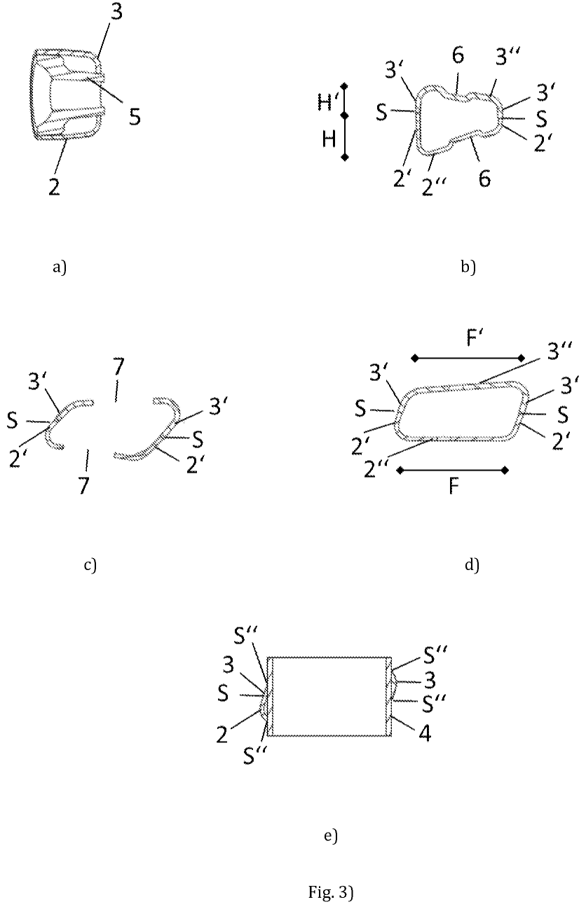

FIG. 3a-e shows cross section representations in different regions along the link according to the invention from FIG. 2.

FIGS. 1 and 2 show a sample embodiment of a link (1) according to the invention, for example as a tensile or compressive link, which can be provided in the chassis region of a motor vehicle for example, especially preferably in the region of the front axle and/or for example in the region of the rear axle. The link (1) comprises at least one middle section (M) and at least two end sections (E, E′). The end sections (E, E′) comprise connecting points for receiving linking and/or joining elements. In particular, the middle section (M) of the link (1) is formed from at least two shells (2, 3), which may consist of one material or different materials and with the same or different thicknesses at least in a region. Preferably, the shells consist of a lightweight steel, such as a steel of high manganese content, with the same or different thickness at least in a region between 0.3 and 4.5 mm, as a result of which complex geometries can be produced with high strengths at the same time in a cost-effective manner, for example by deep drawing. The use of aluminum and/or fiber composite materials is also conceivable. The shells (2, 3) are preferably joined together in the butt joint by integral bonding via a welded seam (S, S′), for example via a laser hybrid or MAG welded seam. The first end section (E) is designed for example as a continuation (8) of the middle section (M) of the link (1), formed from at least two shells (2, 3). Before, during and/or after the shaping process of the shells (2, 3), each time at least one punching is produced in exact position in the sheets which are formed into shells, especially half-shells (2, 3), or alternatively free regions are taken into account already during the trim cutting, so that after the forming and joining of the two half-shells (2, 3) an opening results, forming a through opening in which a sleevelike means (5) can be received or integrated in the form of a sleevelike receiving piece. The opening may also be introduced, for example, after the shaping process. The sleevelike receiving piece (5) is integrated by integral bonding, force locking and/or form fitting in the end section (E) of the link (1) formed from the shells (2, 3) and serves for receiving linking and/or joining elements not represented, for example, for receiving a wheel guide joint. Not represented here, so-called sleevings can be provided from the material of the half-shells for example at the opening of the first end section, which are made during the shaping process of the half-shells preferably by means of deep drawing in the form of a collar, which may point inwardly or outwardly.

The second end section (E′) is formed by an annular means (4), which is joined by integral bonding, force locking and/or form fitting at least to the middle section (M) of the link (1) and serves for receiving of linking and/or joining elements not represented, for example, for receiving a rubber/metal bearing. The means is an annular receiving piece (4), which is joined to the two half-shells (2, 3) by integral bonding via a welded seam (S″), such as a laser hybrid or MAG welded seam. To increase the connection surface and thus enhance the safety of the connection between the middle section (M) and the annular receiving piece (4), the shells (2, 3) forming at least the middle section (M) protrude at least in part into the end section (E′), which is designated by (9). An all-around encircling of the annular receiving piece (4) by the shells (2, 3) may be employed if necessary.

In the region of the first end section (E) of the link (1), embossings or corrugations (6) are formed, which may result in better rigidity of the link (1), especially a stiffening of the end section (E).

Moreover, the link (1) may be provided with cavities (7), which may contribute to a weight reduction.

FIGS. 3a to 3e show cross sections in various regions along a link (1) according to the invention. FIG. 3a shows a first cross section (A-A) in a first region. In this region, the shells, especially half-shells (2, 3), comprise a bottom (2″, 3″) and a frame (2′, 3′) in part at each end. The punchings of the at least one-sided frame (2′, 3′) in the first region are made before, during and/or after the shaping process or, alternatively, are provided already during the trim cutting of the sheets. Thanks to a local contacting in a region between the bottoms (2″, 3″) of the half-shells (2, 3), a rigid attachment of the sleevelike receiving piece (5) is made possible. The sleevelike receiving piece (5) is integrated partially flush within the through opening of the link (1) by integral bonding, force locking and/or form fitting. Depending on the linking and/or joining element, different configurations are conceivable with different shapes, for example, with different external as well as internal diameters. For the exemplary receiving of the sleevelike receiving piece (5) in the end section (E) of the link (1), the diameter of the opening or the through opening is chosen larger on one side than on the opposite side. This may facilitate for example the introducing of the sleevelike receiving piece (5).

FIG. 3b shows a second cross section (B-B) in a second region. In this region, the half-shells (2, 3) have a bottom (2″, 3″) and in each case two adjoining frames (2′, 3′) as a single piece. One notices that the two half-shells (2, 3) are joined together in the butt joint by a welded seam (S), such as a laser hybrid or MAG welded seam. It is further noticed that the thicknesses of the two shells (2, 3) are not the same, since the one half-shell (2) has a lesser thickness of 2.15 mm, for example, than that of the other half-shell (3) of 2.75 mm, for example, which allows a weight reduction. Thanks to the configuration of the link (1) according to the invention, the heights (H′) of the frames (3′) of the half-shell (3) are larger in comparison to the heights (H) of the frames (2′) of the half-shell (2). The individual frames (2′, 3′) also have different and locally varying heights (H,H′), the overall height of the component (link) possibly varying individually or along the length. Furthermore, the bottoms (2″, 3″) of the half-shells (2, 3) each have an embossing or corrugation (6) to stiffen the link (1).

In a third region (C-C), FIG. 3c shows that the heights (H′) of the frames (3′) of the half-shell (2) are substantially identical, while the heights (H) of the frames (2′) of the half-shell (2) are different in configuration. In the bottom (2″) of the one half-shell (2) at least one cavity (7) may be punched out, for example in order to reduce the weight.

Besides the almost identical heights (H, H′) of the frames (2′, 3′) of the half-shells (2, 3) in a fourth region (D-D), FIG. 3d shows that the widths (F, F′) of the bottoms (2″, 3″) of the half-shells (2, 3) are also almost identical.

Finally, FIG. 3e shows in a fifth region (G-G) a cross section through a region in the end section (E′). One notices how the annular receiving piece (4) is attached to the two half-shells (2, 3) by a welded seam (S″), such as a laser hybrid or MAG welded seam.

The link according to the invention may also have end sections corresponding each time only to the configuration of the first end section (E) or only to the configuration of the second end section (E). For example, more than two end sections may also be present.

### LIST OF REFERENCE SYMBOLS

1 Link
2,3 Shell, half-shell
2′, 3′ Frame of the half-shell
2″, 3″ Bottom of the half-shell
4 Annular receiving piece
5 Sleevelike receiving piece
6 Embossing or corrugation
7 Cavity
8 Continuation of the half-shells
9 Encompass region of the half-shells
A-A Cross section plane for FIG. 3a
B-B Cross section plane for FIG. 3b
C-C Cross section plane for FIG. 3c
D-D Cross section plane for FIG. 3d
G-G Cross section plane for FIG. 3e
E, E′ End section
F, F′ Width of the bottom
H, H′ Height of the frame
M Middle section
S, S′, S″ Welded seam

1.-13. (canceled)

14. A link for a wheel suspension of a vehicle, the link comprising:
at least one middle section formed from at least two shells; and
at least two end sections having connecting points for receiving at least one of linking elements or joining elements.

15. The link of claim 14 wherein the at least two shells are substantially U-shaped in cross section and are joined together by at least one of integral bonding, force locking, or form fitting in a butt joint or a lap joint.

16. The link of claim 15 wherein each of the substantially U-shaped at least two shells comprises as a single piece a bottom and two adjoining frames, which make an angle with the bottom.

17. The link of claim 16 wherein a height of the two adjoining frames is constant in a longitudinal direction at least for a portion of the at least one middle section.

18. The link of claim 16 wherein a height of the two adjoining frames is variable in a longitudinal direction at least for a portion of the at least one middle section.

19. The link of claim 16 wherein a width of the bottom is constant in a longitudinal direction at least for a portion of the at least one middle section.

20. The link of claim 16 wherein a width of the bottom is variable in a longitudinal direction at least for a portion of the at least one middle section.

21. The link of claim 14 wherein at least a portion of a cross section of the at least one middle section is constant in configuration in a longitudinal direction.

22. The link of claim 14 wherein at least a portion of a cross section of the at least one middle section is variable in configuration in a longitudinal direction.

23. The link of claim 14 wherein the at least two shells have different thicknesses at least at some point along the at least one middle section.

24. The link of claim 14 wherein the at least two shells comprise steel, aluminum, fiber composite, or a sandwich material.

25. The link of claim 14 wherein at least one of the at least two shells comprises a lightweight steel.

26. The link of claim 14 further comprising means for receiving the at least one of the linking elements or the joining elements at least at one of the at least two end sections, wherein the means for receiving is annular and is connected by at least one of integral bonding, force locking, or form fitting to the at least one middle section.

27. The link of claim 14 further comprising means for receiving the at least one of the linking elements or the joining elements at least at one of the at least two end sections that is configured as a continuation of the at least one middle section formed by the at least two shells, wherein the means for receiving is sleeve-like and is integrated by at least one of integral bonding, force locking, or form fitting in the at least one of the at least two end sections.

28. The link of claim 14 configured as a tensile link.

29. The link of claim 14 configured as a compressive link.

30. The link of claim 14 wherein at least one of the at least two shells includes at least one embossing.

31. The link of claim 14 wherein at least one of the at least two shells includes at least one cavity.
